(19) United States
(12) Patent Application Publication
(10) Pub. No.: US 2015/0296851 A1
(43) Pub. Date: Oct. 22, 2015

(54) Compositions for Balancing Gut Microbiota and the Preparation and the Uses thereof

(71) Applicants: SHANGHAI JIAO TONG UNIVERSITY, Shanghai (CN); PERFECT (CHINA) CO., LTD, Zhongshan, Guangdong (CN)

(72) Inventor: Liping Zhao, Shanghai (CN)

(21) Appl. No.: 14/646,468

(22) PCT Filed: Nov. 26, 2012
(86) PCT No.: PCT/CN2013/087813

§ 371 Date: May 21, 2015

(30) Foreign Application Priority Data
Nov. 27, 2012 (CN) 201210489456.X

(51) Int. Cl. A23L 1/29; A23L 1/20; A23L 1/36; A23L 1/304; A23L 1/308; A23L 1/212; A23L 1/302; A23L 1/303; A23L 1/10; A23L 1/30

(52) U.S. Cl. CPC A23L 1/296; A23L 1/10; A23L 1/20; A23L 1/36; A23L 1/3002; A23L 1/308; A23L 1/212; A23L 1/302; A23L 1/303; A23L 1/304; A23V 2002/00

(57) ABSTRACT

A composition includes a first composition, a second composition and a third composition. The first composition comprises edible ingredients from fruit, seeds, or other parts of plants; the second composition comprises bitter gourd, a first oligosaccharides, a first fermentable dietary fiber, or a combination thereof; and the third composition comprises a second oligosaccharides and a second fermentable dietary fiber. The composition is used for targeting and restoring structural balance of gut microbiota and relieving chronic inflammation.

### TECHNICAL FIELD

The present application relates to compositions for promoting health. More specifically, the application provides compositions for promoting beneficial gut microbiota or inhibiting opportunistic pathogens, as well as the preparation and use of the composition.

### BACKGROUND

Unless otherwise indicated herein, the materials described in this section are not prior art to the claims in this application and are not admitted to be prior art by inclusion in this section. All references are incorporated herein in their entirety.

Metabolic syndrome is characterized by, among others, hyperglycemia, hypertension, high cholesterol and overweight. Its most important features are central obesity and insulin resistance. Metabolic syndrome is a high-risk predisposing factor for many chronic diseases such as diabetes, coronary heart disease, cerebral apoplexy and colon cancer, making the metabolic syndrome one of the major health threats. The development of new technologies and methods for treating metabolic syndrome is of vital importance to public health.

Currently, control of metabolic syndrome is mainly through use of drugs and changing the composition of diet. For a long while, because there is no breakthrough in understanding the causes of metabolic syndrome, the use of drugs has been limited to addressing the symptoms instead of the cause of metabolic syndrome. Although the symptoms may be relieved, disease processes are not blocked, and most patients still develop different chronic diseases. Attempts to address metabolic syndrome by changing diet composition does not fare better, because the past efforts generally emphasize the role of a particular nutrient while ignoring the underlying cause of metabolic syndrome. For example, various iterations of low-sugar food to control blood sugar or low-fat food to control blood lipids are popular mainstay, yet success is uncommon, improvement is limited, because the underlying cause of metabolic syndrome is not properly addressed. If diet composition is changed substantially, such as when shifting from high-calorie food of animal origin to plant-based food, or drastic reduction of calorie intake, patients tend to suffer from various adverse reactions, such as unbearable food craving or increased level of inflammatory response, resulting in the failure to strictly follow medical guidance in long term.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

The present application relates to an unexpected discovery that a new composition is effective in promoting beneficial intestinal bacteria while inhibiting opportunistic pathogens, resulting in prevention and/or treatment of metabolic syndrome.

In one aspect, the application provides compositions for improving gut microbiota population. In one embodiment, the composition includes a first composition, a second composition and a third composition. The first composition may include an ingredient from an edible plant. The second composition may include bitter gourd, a first fermentable dietary fiber and a first oligosaccharide; and the third composition may include a second fermentable dietary fiber and a second oligosaccharide. The first and the second fermentable dietary fiber may or may not be the same. The first and the second oligosaccharide may or may not be the same.

The ingredients in the compositions listed above may include seeds, fruits or other parts or their extracts of a plant that is edible and known or recognized to have medicinal or therapeutic activities.

When ingested by a subject in effective amount, the composition may be capable of increasing a first gut microbiota population including population a short-chain fatty acid (SCFA)-producing bacteria, decreasing a second gut microbiota population including an endotoxin producing bacteria in the subject, or both. For example, the first composition may be capable of increasing the first gut microbiota population, and the second composition may be capable of decreasing the second gut microbiota population in the subject.

The compositions in this application may be food, nutriceutical products, supplements, or healthcare products. The composition may be administered orally to a subject in need thereof. The subject may be a human being. The subject may suffer from metabolic syndrome.

In another aspect, this application provides methods for making the above compositions. In one embodiment, the method includes mixing adlay, oat, buckwheat, white bean, yellow corn, red bean, soybean, yam, big jujube, peanut, lotus seed, and wolfberry to provide a first composition; mixing bitter gourd, a first fermentable dietary fiber and a first oligosaccharides to provide a second composition; and mixing a second fermentable dietary fiber and a second oligosaccharides to provide a third composition.

In a third aspect, the application provides methods for balancing gut microbiota and/or improving metabolic syndrome in a subject. In one embodiment, the method includes the steps of administering to the subject an effective amount of a treatment composition. The treatment composition may include the above described first composition, the above described second composition, the above described third composition, or any combination of the three compositions.

Compared to existing techniques, the solutions in the present application have, among others, one or more following surprising advantages: when administered to the subject, the compositions are capable of balancing or improve gut microbiota in a subject, improving metabolic syndrome, increasing the amount of short-chain fatty acid-producing bacteria and decreasing the amount of endotoxin-producing bacteria; the compositions may be administered to a subject via various forms and may alleviate, relieve, remedy, prevent or ameliorate metabolic syndrome or symptoms of metabolic syndrome and/or restore health to the subject.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments arranged in accordance with the disclosure and are, therefore, not to be considered limiting of its scope, the disclosure will be described with additional specificity and detail through use of the accompanying drawings, in which:

FIG. 1 shows the fingerprints of the 16S rRNA gene V3-DGGE of the gut microbiota population from the volunteers before and after the intervention.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

In one aspect, the application provides novel compositions that are effective in promoting the beneficial gut microbiota population or inhibiting the opportunistic pathogens. The composition may be a nutritional intervention composition. The composition may be made from common food ingredients and may not contain any artificial synthetic colors, hormones, sweeteners, flavoring agents, preservatives, or any illicit drugs, thus is safe and nontoxic. The composition overcomes the insufficiency of the existing nutritional intervention methods for treating metabolic syndrome, and is effective in inhibiting intestinal opportunistic pathogens, increasing the number of beneficial bacteria, reducing chronic inflammation, thus fundamentally improving metabolic syndrome symptoms.

In one embodiment, the composition includes a first composition, a second composition and a third composition. In one embodiment, the first composition comprises an ingredient from an edible plant. The second composition may contain bitter gourd, a first fermentable dietary fiber and a first oligosaccharide; and the third composition contains a second fermentable dietary fiber and a second oligosaccharide.

The first composition may be capable of increasing short-chain fatty acid (SCFA)-producing bacteria population in a subject. In one embodiment, the first composition may include whole cereals, beans, nuts, peanuts, corn (including, for example, yellow corn, white corn, red corn, purple corn, black corn, bi-color corn, multi-color corn), cloves, star anise, fennel, thistle, yam, hawthorn, purslane, Zaocys dhumnades, plum, papaya, hemp seed, odoratum, fragrant Solomonseal rhizome, licorice, angelica, ginkgo, white lentils, white lentils flower, longan pulp (also called Gui Yuan), cassia, lily, nutmeg, cinnamon, amla, bergamot, almond (either sweet or bitter), Hippophae rhamnoides, oysters, Gorgon fruit, pepper, red beans, donkey hide gelatin, inner wall of chicken gizzard, malt, kelp, jujube (including, for example, Zizyphus jujube, sour jujube, or black jujube), Momordica grosvenori, Yu Li seed, honeysuckle flower, olive, Houttuynia cordata, ginger (including, for example, Zingiber officinale, fresh or dried), Hovenia dulcis Thunb, medlar, gardenia, Amomum villosum, Pang Dahai, Poria, citron, Elsholtzia, peach kernel, mulberry leaf, mulberry, orange, bellflower, Alpinia oxyphylla, lotus leaf, semen raphani, lotus seed, Alpinia officinarum hance, Lophatherum gracile, fermented soybean, chrysanthemum, chicory, Huang Jiezi, Huang Jing, perilla seed, perilla seed, Ge Gen, black sesame seed, black pepper, Sophora japonica, sophora flower, dandelion, honey, Torreya, semen Ziziphi Spinosae, Rhizoma imperatae, reed rhizome, viper, orange peel, adlay (also known as coix seed or Yi Ren), peppermint, Allium macrostemon Bunge, raspberry, ageratum, or any combination thereof.

The beans may include soybeans, black beans, broad beans, white beans, peas, mung bean, long bean, Pigeonpea, four winged bean, chickpea, lentil, red beans, Pinto bean, green bean, kidney bean, Navy bean, Pea bean, Lima bean, black bean, Garbanzo peas, black-eyed peas, lablab bean or any combination thereof. In one embodiment, the lablab bean may include white Hyacinth bean and white Hyacinth flowers. In one embodiment, the lablab bean may include bean from a plant of Hyacinthus.

The nuts may include peach seeds, almonds, gingko seeds, or a combination thereof. In one embodiment, the almonds may include sweet almonds or bitter almonds.

The whole cereals may include rice, wheat, barley, quinoa, rye, triticale, buckwheat, or oat. The buckwheat may include common buckwheat, bitter Tartary buckwheat, or a combination thereof. In one embodiment, the buckwheat may include seeds from a plant of Gagopyrum, Erigonum, or Fallopia. The oat may include seeds from a plant of Avena.

In one embodiment, the first composition may include powder or granular particles of the whole cereals. In one embodiment, from about 15 to about 100% of the whole cereal granular particles have a diameter of 0.65 mm or above. In some embodiments, at least about 15%, at least about 20%, at least about 25%, at least about 30% or at least about 50% of the granular particles of the whole cereals have diameter of 0.65 mm or above.

In one embodiment, the first composition may include buckwheat, oats, adlay, or a combination of any two, three, four, five, or six ingredients selected from the group. In another embodiment, the first composition may include oats, white Hyacinth bean, adlay or a combination of any two, three, four, five, or six ingredients selected from the group. In another embodiment, the first composition includes buckwheat, oat, yam or any combination of two, three, four, five, or six ingredients selected from the group. For example, the first composition includes from about 10 to about 30% of adlay by weight, from about 5 to about 30% of oat by weight, from about 5 to about 50% of buckwheat by weight, from about 5 to about 20% of white Hyacinth bean by weight, from about 5 to about 30% of yam by weight, or any combination thereof. In one embodiment, the yam is dried yam.

In one embodiment, the first composition may include adlay, oat, buckwheat, white bean, yellow corn, red bean, soybean, yam, peanut, lotus seed, and wolfberry. For example, the first composition includes about 20% by weight of adlay, about 15% by weight of oat, about 10% by weight of buckwheat, about 10% by weight of white Hyacinth beans, about 5% by weight of yellow corn, about 5% by weight of red bean, about 5% by weight of soybean, about 10% by weight of dried yam, about 5% by weight of big jujube, about 5% by weight of peanut, about 5% by weight of lotus seed, and about 5% by weight of wolfberry.

In one embodiment, the first composition may include adlay, oat, buckwheat, lablab bean, yellow corn, red bean, soybean (or soy protein), yam, big jujube, peanut, lotus seed, and wolfberry. For example, the amount of the adlay may be from about 10 to about 30%, such as about 10%, about 15%, about 20%, about 25%, or about 30%, by weight of the first composition. The amount of the oat may be from about 5 to about 25%, such as about 5%, about 10%, 15%, 20%, or 25%, by weight of the first composition. The buckwheat may be from about 1 to about 20%, such as about 1%, 5%, about 10%, about 15%, or about 20%, by weight of the first composition. The amount of the lablab bean may be from about 1 to about 20%, such as about 1%, about 5%, about 10%, about 15%, or about 20%, by weight of the first composition. The amount of the yam may be from about 1 to about 20%, such as about 1%, about 5%, about 10%, about 15%, or about 20%, by weight of the first composition. In some embodiments, the yam may be in dried, frozen, canned, or in extracted form. The amount of wolfberry may be from about 5 to about 25%, such about 5%, about 10%, about 15%, about 20%, or about 25%, of the first composition by weight. The amount of soybean may be from about 1 to about 20%, such as about 1%, about 5%, about 10%, about 15%, or about 20%, of the first composition by weight.

In one embodiment, the amount of the adlay, oat, buckwheat, white bean, and yam in the first composition may be about 20%, about 15%, about 10%, about 10%, and 10% by weight, respectively, of the first composition, and the amount of each of the yellow corn, red bean, soybean, big jujube, peanut, lotus seed, and wolfberry may be about 5% by weight of the first composition.

In one embodiment, the first composition may include, per 100 g, Vitamin A from about 3 to about 857 μgRE, Vitamin D from about 0.01 to about 5 μgRE, Vitamin E from about 2 to about 79.09 mg, Vitamin Bi from about 0.01 to about 1.89 mg, Vitamin B2 from about 0.01 mg to about 1.4 mg, Vitamin B₆ from about 0.01 to about 1.2 mg, Vitamin B12 from about 0.1 to about 2.4 mg, Vitamin C from about 1 mg to about 1170 mg, Niacin from about 0.5 mgNE to about 28.4 mg, calcium (Ca) from about 60-2458 mg, phosphorus (P) from about 200 to about 1893 mg, potassium (K) from about 350 to about 1796 mg, sodium (Na) from about 8 to about 2200 mg, magnesium (Mg) from about 100 to about 350 mg, and iron (Fe) from about 2 to about 20 mg.

In one embodiment, the first composition includes from about 5 to about 40% or from about 10 to about 20% of protein by weight, from about 30 to about 80% or from about 50 to about 70% of carbohydrate by weight, from about 0.5 to about 30% or from about 2 to about 15% of fat by weight, from about 0.5 to about 30% or from about 2 to about 15% of dietary fiber by weight, from about 0.1 to about 5% or from about 0.5 to about 1% of vitamin(s) by weight, or from about 0.1 to about 2% or from about 0.8 to about 1.2% of mineral(s) by weight.

In one embodiment, every 100 grams of the first composition may provide a total of from about 300 to about 400 calories. In one embodiment, the amount of protein, carbohydrate, fat, fiber, vitamin, and mineral may be from about 13 to about 15%, from about 60 to about 65%, from about 4 to about 6%, from about 5 to about 7%, from about 0.5 to about 1%, and from about 0.8 to about 1.2% by weight, respectively, of the first composition.

The first composition may be in the form of rice, porridge, gruel, congee, or cooked rice. The starch component in these forms is less likely to degrade after steaming, boiling or other forms of cooking and therefore less likely to elevate blood glucose level.

The second composition may be capable of reducing endotoxin-producing bacteria population in a subject. In one embodiment, the second composition may consist essentially of the bitter gourd, the first fermentable dietary fiber, and the first oligosaccharides. The bitter gourd may include powder of whole fruits from a plant of Momordica charantia or its extract. The powder of fruits may be produced by freeze drying or spray drying process. The first fermentable dietary fiber may include Fibersol-2, resistant starch, polydextrose, cellulose, hemicellulose, pectin, gum, or a combination thereof. The first oligosaccharides may include independently fractooligosaccharides, galacto-oligosaccharides, lactulose, xylo Isomaltooligosaccharide, soybean oligosaccharides, oligo glucose, Stachyose, Lactosucrose, or a combination thereof.

In one embodiment, the second composition may include from about 15 to about 99.8% of the bitter gourd by weight, from about 0.1 to about 51% of the first fermentable dietary fiber by weight, and from about 0.1 to about 34% of the first oligosaccharide by weight. In one embodiment, the ratio of the bitter gourd and oligosaccharides in the second composition may be from about 10:1 to about 1:1 by weight. In one embodiment, the amount of the bitter gourd may be from about 15 to about 55%, such as about 15%, about 20%, about 30%, about 35%, about 40%, about 45%, about 50%, or about 55%, of the second composition by weight. In one embodiment, the amount of oligofructose may be from about 10 to about 30%, such as about 10%, about 15%, about 20%, about 25%, or about 30%, of the second composition by weight. In one embodiment, the amount of isomaltooligosaccharide may be from about 5 to about 25%, such as about 5%, about 10%, about 15%, about 20%, or about 25%, of the second composition by weight.

The second composition may be in granular or powder form. For example, the second composition may be a granular infusion and can be dissolved or suspended in water. For example, the bitter gourd may be in the form of powder.

The ingredients in the compositions may be in the form of powder, granule, particles, noodle, sheets, crystalline, paste, or solution. The ingredient powder, such as bitter gourd, may be produced by freeze-drying or spray drying. In one embodiment, the granular particles, noodles, and sheets may be made by pulverizing a mixture of the ingredients into a particle or powdery mixture and forming the particle or powdery mixture into granular particles, noodles, or sheets. In one embodiment, from at least about 1% to at least about 70% of the granular particles in the composition has a diameter of 0.65 mm or above.

The compositions in the present application may be used as food products, healthcare products, or nutraceuticals, such as dietary supplements. When ingested by a subject in effective amount, the composition may be capable of increasing a first gut microbiota population containing a short-chain fatty acid (SCFA)-producing bacteria, decreasing a second gut microbiota population containing an endotoxin producing bacteria in the subject, or both.

The composition may be mixed with pharmaceutically acceptable carrier to form pharmaceutical compositions. “Pharmaceutically acceptable carriers” include solvents, dispersants, coatings, fillers, adhesives, bulking agents, biologically active agents such as antibacterial or antifungal agents, and isotonic and delayed absorption agents, which are suitable for drug delivery.

The composition may be formulated to be compatible with its intended route of administration. (See, for example, U.S. Pat. No. 6,756,196, which is incorporated herein in its entirety.) Examples of routes of administration include oral, sublingual, buccal, and rectal administration, as well as parenteral administration. For instance, a composition of the present application may be in the form of tablet, capsule, pill, bar, granule, powder, film, microcapsule, aerosol, gruel, congee, porridge, rice or cooked rice, spirit, tincture, tonic, liquid suspension, or syrup. It is advantageous to formulate oral compositions in dosage unit form for ease of administration and uniformity of dosage. “Dosage unit form,” as used herein, refers to physically discrete units suited as unitary dosages for the subject to be treated, each unit containing a predetermined quantity of active ingredients calculated to produce the desired therapeutic effect in association with the required pharmaceutical carrier.

The composition of the present application can be used to promote beneficial intestinal bacteria and inhibit opportunistic pathogens. Therefore, the application provides systems for nutritional intervention for reducing bodyweight or improving metabolic syndrome in a subject. The system may include the above compositions and an instruction configured to instruct the subject on how to use the first composition, the second composition, and the third composition.

For example, an effective amount of the composition may be administered to a subject in need thereof via a proper route such as those described above.

As used herein, a “subject” refers to a human or animal, including all mammals such as primates (particularly higher primates), sheep, dog, rodents (e.g., mouse or rat), guinea pig, goat, pig, cat, rabbit, and cow. In a preferred embodiment, the subject is a human. In another embodiment, the subject is an experimental animal or animal suitable as a disease model.

A subject to be treated may be identified in the judgment of the subject or a health care professional, and can be subjective (e.g., opinion) or objective (e.g., measurable by a test or diagnostic method). For example, a subject to be treated may have a low level of beneficial intestinal bacteria and a high level of opportunistic pathogens, or has been diagnosed with metabolic syndrome.

A “treatment” is defined as administration of a substance to a subject with the purpose to cure, alleviate, relieve, remedy, prevent, or ameliorate a disorder, symptoms of the disorder, a disease state secondary to the disorder, or predisposition toward the disorder.

An “effective amount” is an amount of a composition that is capable of producing a medically desirable result in a treated subject. The medically desirable result may be objective (i.e., measurable by some test or marker) or subjective (i.e., subject gives an indication of or feels an effect).

The dosage required for treating a subject depends on the choice of the route of administration, the nature of the formulation, the nature of the subject's illness, the subject's size, weight, surface area, age, gender, other drugs being administered, and/or the judgment of a health care professional.

The application further provides instructions for taking the above compositions. In one embodiment, the subject is instructed to take the first composition as a main course of food, take the second composition from about 0.25 to about 1 hour before meal, and take the third composition from about 2 to about 5 hours before meal or with breakfast.

In one embodiment, the first composition may be in the form of a porridge, a gruel, or a congee, and used as food by a subject, optionally in combination with fresh vegetables. The intake amount of the first composition may be set to the extent where the subject no longer feels hungry. The second composition may be in the form of a granular infusion. The granular infusion may be suspended or dissolved in warm water and consumer by a subject. The daily intake amount of the second composition may be from about 5 to about 100 grams, from about 30 to about 80 grams, or from about 40 to about 60 grams. For example, the subject may be instructed to take 2-3 bags at 20 g/bag per day dosage of the second composition with warm water. The third composition may also be a granular infusion. The daily intake amount of the third composition may be from about 5 to about 200 grams, from about 30 to about 100 grams, or from about 50 to about 150 grams. The third composition may be suspended or dissolved in from about 300 to about 1500 ml or from about 800 to about 1200 ml of water and then consumed by a subject with an empty stomach in the morning.

The representative administration cycle of the composition of the present application is from one week to several months, such as one week, two weeks, one month, two months, four months or eight months. When the level of beneficial gut microbiota in the subject's body begins to rise and the level of opportunistic pathogens begins to decline, the dosage of the composition may be reduced gradually. When the composition of the gut microbiota is restored to normal, the administration may be terminated.

The following examples are for illustration of the present application. The embodiments were implemented under the premise of the technical solution of the present application. The detailed implementation methods and specific operation processes are provided. These examples are not intended to limit the scope of the application.

### EXAMPLE 1

### Effective Treatment of an Obese Volunteer by an Example Composition

The composition embodying the present application in a granular infusion form was administered to a volunteer with Body Mass Index (BMI) of 58.78 on a daily basis for 24 weeks. The physiological and biochemical indicators of the body and the changes in the gut microbiota during the administration were systematically monitored. At the end of the intervention, the opportunistic pathogens in the intestine declined; the beneficial bacteria in the intestine increased; intestinal endotoxins entering the host's circulatory system were reduced, the inflammatory response level in the volunteer was lowered; each and every parameter of the metabolic syndrome of the volunteer was significantly improved; and BMI was dropped to 41.50.

(1) The physical conditions of the volunteer before intervention

The volunteer was a 26-year-old male, having a height of 172.5 cm, a weight of 174.9 kg, a BMI of 58.78, and a waistline of 156.1 cm. According to the BMI evaluation criteria for Asian adults, this volunteer was a severely obese patient. After a systematic physical examination, this volunteer was diagnosed with severe metabolic syndrome. His physiological and biochemical indicators are shown in Table 1 below.

(2) The composition used for intervention and treatment of the patient

For intervention and treatment of the patient, a granular infusion form of an example composition was used. The example composition has the following formula: the amount of bitter gourd powder was 35%, the amount of wolfberry powder was 15%, the amount of soy protein powder was 10%, the amount of oligofructose was 20%, the amount of isomaltooligosaccharide was 15%, and the amount of wheat fiber was 5%. This composition had good inhibitory effects for intestinal opportunistic pathogens, and was capable of specifically conditioning the contents of the intestinal flora, as demonstrated by the results obtained.

The granular infusion was taken orally 2-3 bags per day (20 g/bag), after dissolving in warm water.

(3) Use of other intervention food

A. Food-like Composition No. 1. The Food-like Composition No. 1 is an example composition in porridge form. The composition has the ingredients including adlay, oat, buckwheat, white bean, yellow corn, red bean, soybean, yam, big jujube, peanut, lotus seed, and wolfberry. This food-like composition was a whole-grain product, with balanced protein, carbohydrates and fat. It was rich in dietary fiber. It was capable of supplementing the dietary and nutritional need of human body such as vitamins and minerals.

The patient consumed the Food Composition No. 1 as staple food, together with a suitable amount of fresh vegetables during each meal. The food intake was not restricted, and the patient was at liberty to consume the food until he no long felt hungry.

B. Food-like Composition No. 3: The Food-like Composition No. 3 is an example composition in granular infusion form. The composition has the ingredients including oligomeric factor and fermentable dietary fiber. This food-like composition was capable of clearing the intestinal tract, excluding stool, promoting beneficial intestinal bacteria, increasing the production of gas by the beneficial intestinal bacteria, speeding up intestinal motility and emptying, and removing pathogenic bacteria and endotoxin producing bacteria.

This food-like composition contained 30-100 grams of oligosaccharides. The patient consumed this food-like composition every morning prior to other food, along with 800-1200 ml of water.

(4) Evaluation of the changes in the physiological and biochemical indicators of the body and the effects of the intervention

TABLE 1 show the physiological and biochemical indicators of the volunteer in example I after 9 weeks and 23 Weeks of Intervention

TABLE 1

| | Measurements | | | |
|---|---|---|---|---|
| | 0 days | 9 weeks | 23 weeks | |
| | before | after | after | Normal |
| Item | intervention | intervention | intervention | range |
| Weight (kg) | 174.9 | 144.8 | 123.5 | — |
| BMI | 58.78 | 48.66 | 41.50 | 18-23 |
| fasting blood glucose-FBG | 8.95 | 4.76 | 5.40 | 3.90-6.10 |
| (mmol/L) | | | | |
| fasting insulin FINS | 58.7 | 25.8 | 23 | 6-27 |
| (μIU/ml) | | | | |
| glycated hemoglobin (%) | 7.58 | 5.44 | 4.52 | 3.8-5.8 |
| insulin resistance | 23.35 | 5.46 | 5.52 | |
| indicators | | | | |
| triglycerides (mmol/L) | 2.68 | 1.72 | 1.18 | 0-1.7 |
| total cholesterol (mmol/L) | 5.53 | 4.64 | 4.78 | 3.00-5.17 |
| high density lipoprotein - | 0.89 | 0.70 | 0.82 | >0.91 |
| HDL (mmol/L) | | | | |
| low-density lipoprotein- | 3.42 | 3.15 | 3.42 | 0-4.16 |
| LDL (mmol/L) | | | | |
| AST (U/L) | 122.0 | 51 | 31 | 10-47 |
| alanine aminotransferase | 97.0 | 50 | 33 | 0-41 |
| (U/L) | | | | |
| gamma glutamyl | 168.0 | 49 | 59 | 0-56 |
| transferase (U/L) | | | | |
| fatty liver disease-FLD | Severe | Severe | Moderate | Normal |
| systolic pressure-SBP | 150.0 | 120 | 120 | ≦140 |
| (mmHg) | | | | |
| diastolic pressure-DBP | 110.0 | 80 | 75 | ≦90 |
| (mmHg) | | | | |
| C reactive protein (mg/L) | 14.1 | 9.4 | 9.51 | 0-10 |
| lipopolysaccharide | 7.03 | 2.29 | 4.78 | — |
| endotoxin-binding protein | | | | |
| (μg/ml) | | | | |
| interleukin 1β (pg/ml) | 0.12 | 0.14 | 0.09 | — |
| interleukin 6 (pg/ml) | 6.71 | 4.46 | 2.76 | — |
| tumor necrosis factor | 1.10 | 2.14 | 1.66 | — |
| alpha, TNF (pg/ml) | | | | |
| adiponectin (μg/ml) | 2.00 | 2.09 | 4.27 | — |

A. The intervention by the composition of the present application significantly reduced BMI and drastically improved the metabolic syndrome. Compared with the volunteer's physiological and biochemical indicators 0 day before the intervention, after 9 weeks and 23 weeks of intervention, the volunteer's weight and BMI dropped significantly; the decrease in the indicators of fasting glucose, fasting insulin, glycated hemoglobin, and insulin resistance directly reflects the significant improvement of the state of glucose homeostasis under the intervention; the decline in triglycerides and total cholesterol indicates the improvement of the body's lipid metabolism; the significant reduction and gradual return to the normal range of aspartate aminotransferase, alanine aminotransferase and γ-glutamyl transferase indicate the mitigation of the liver cell damage; at the same time, both the symptoms of fatty liver disease and the blood pressure were relieved; the decrease of both the inflammatory indicator C-reactive protein and the inflammatory factor interleukin-6 suggests that the level of the inflammatory response caused by the gut microbiota population and having a destructive effect to the human body was reduced under the intervention; the increase of the anti-inflammatory factor adiponectin indicates that the function of the body to eliminate inflammatory response recovered after the intervention; the decrease of the lipopolysaccharide endotoxin binding protein suggests that the level of the endotoxin produced by the bacteria and entering the blood was reduced under the intervention. Taken together, these indicators all show that, after the intervention in the volunteer, each parameter of the metabolic syndrome of the volunteer was significantly improved.

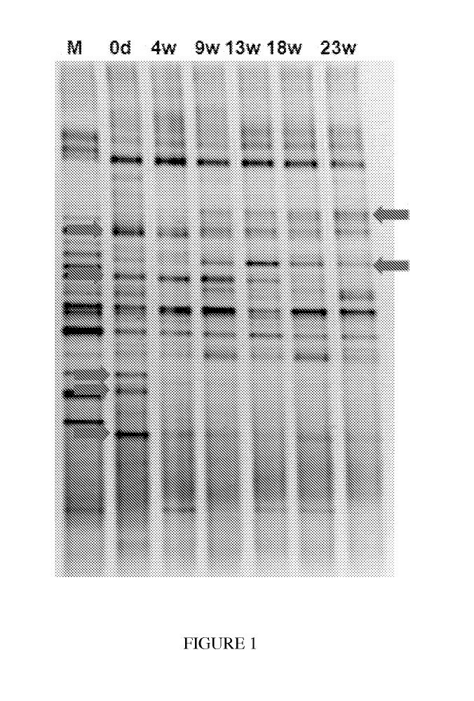

B. The intervention by the composition of the present application significantly changed the composition of the intestinal flora, increasing beneficial bacteria and decreasing harmful bacteria. The changes of the composition of the gut microbiota during the intervention were measured by 16S rRNA gene V3-DGGE fingerprint. As shown in FIG. 1, the 16S rRNA gene V3-DGGE fingerprint shows that the dietary intervention exerted a great impact on the composition of the gut microbiota in this individual. At several points after the intervention, the gut microbiota of the volunteer was relatively similar, indicating that the dietary intervention significantly changed the composition of the intestinal flora.

C. The results of 454 pyrosequencing reveal a significant decrease in Proteobacteria in the volunteer. In particular, the change in Enterobacteriaceae was the most prominent, from 17.90% at −30 d to 0.10% at 9 w and 0.10% at 23 w. Reflected at the genus level, it was manifested by the significant decline of the opportunistic pathogen Enterobacter. In addition, at the genus level, after the dietary intervention, the Faecalibacterium went upward. Faecalibacterium is anti-inflammatory and produces butyrate. It plays an important role in energy metabolism in a host and the protection of the integrity of the intestinal mucosa.

Thus, after the intervention, the number of the opportunistic pathogens in the volunteer declined. The intestinal endotoxins entering the host's circulatory system were reduced, the inflammatory response level in the host was lowered, and the symptoms of metabolic syndrome in the volunteer were effectively relieved.

### EXAMPLE 2

### Effective Treatment of 89 Obese Volunteers by an Example Composition

The same example composition and the intervention regime as described in EXAMPLE 1 was applied to 89 volunteers who suffered from second degree central obesity. The physiological and biochemical indicators and the changes in the gut microbiota during the intervention were systematically monitored for all 89 volunteers. After administering the composition in a granular infusion form on a daily basis for 24 weeks, the opportunistic pathogens in the intestine declined; the beneficial bacteria in the intestine increased; intestinal endotoxins entering the host's circulatory system were reduced, the inflammatory response level in the volunteer was lowered significantly; each and every parameter of the metabolic syndrome of the volunteer was significantly improved; and BMI were significantly reduced.

(1) The physical conditions of the volunteer before intervention

89 volunteers suffering from second degree central obesity were recruited for the application.

(2) The composition used for intervention and treatment of the patient

The same composition as EXAMPLE 1 was used.

(3) Use of other intervention food-like composition

The same composition as EXAMPLE 1 was used.

(4) Evaluation of the changes in the physiological and biochemical indicators of the body and the effects of the intervention

The data shown in TABLE 2 below are mean value±standard deviation, or median (interquartile range). Paired t test (normally distributed data) or nonparametric Wilcoxon test distribution (non-normally distributed data) were analyzed by SPSS 17.0 statistical software. For comparison between week 9 versus −30 days, and week 23 versus −30 days, * denotes P<0.05, ** denotes P<0.01; for comparison between week 9 versus week 23, § denotes P<0.05, §§ denotes P<0.01.

TABLE 2
The physiological and biochemical indicators of the volunteers
in EXAMPLE 2 during the process of dietary intervention

| | Measurements | | | |
|---|---|---|---|---|
| | 30 days | 9 weeks | 23 weeks | |
| | before | after | after | Normal |
| Item | intervention | intervention | intervention | range |
| Weight (kg) | 84.1 | 78.8** | 78.25**^{§} | — |
| | (76.7-92.1) | (71.6-87.6) | (72-87.7) | |
| BMI | 31.51 | 29.81** | 29.50**^{§} | 18-23 |
| | (30.31-33.91) | (28.73-32.24) | (28.43-31.47) | |
| FBG (mmol/L) | 4.90 | 4.74** | 4.93^{§§} | 3.90-6.10 |
| | (4.64-5.28) | (4.46-5.13) | (4.63-5.37) | |
| FINS (μIU/ml) | 11.9 | 10.7** | 9.26**^{§§} | 6-27 |
| | (8.5-17.1) | (6.9-14.3) | (6.10-13.95) | |
| Glycated hemoglobin | 4.34 | 4.83** | 4.78** | 3.8-5.8 |
| (%) | (3.99-4.60) | (4.63-5.06) | (4.57-5.02) | |
| Insulin resistance | 2.63 | 2.40** | 1.96**^{§} | |
| indicators | (1.80-3.92) | (1.47-3.15) | (1.27-3.10) | |
| Triglycerides | 1.55 | 1.17** | 1.29** | 0-1.7 |
| (mmol/L) | (1.09-2.25) | (0.86-1.80) | (0.79-1.88) | |
| Total cholesterol | 4.45 ± 0.77 | 4.13 ± 0.77** | 4.38 ± 0.78^{§§} | 3.00-5.17 |
| (mmol/L) | | | | |
| HDL (mmol/L) | 1.05 ± 0.19 | 0.98 ± 0.21** | 1.09 ± 0.23*^{§§} | >0.91 |
| LDL (mmol/L) | 2.46 ± 0.87 | 2.47 ± 0.76 | 2.61 ± 0.70*^{§} | 0-4.16 |
| AST (U/L) | 21 | 21 | 22 | 10-47 |
| | (16-29) | (17-27) | (19-25) | |
| Alanine amino- | 21 | 19** | 17** | 0-41 |
| transferase (U/L) | (13-36) | (13-28) | (10.5-26) | |
| gamma glutamyl | 27 | 22** | 22** | 0-56 |
| transferase (U/L) | (20-36) | (18-32) | (16-31) | |
| SBP (mmHg) | 127 | 123** | 125 | ≦140 |
| | (121-135) | (116-131) | (115-133) | |
| DBP (mmHg) | 89 | 84* | 89 | ≦90 |
| | (80-97) | (79-95) | (80-95) | |
| C reactive protein | 6.60 | 4.90** | 5.93*^{§} | 0-10 |
| (mg/L, n = 67) | (5.10-8.20) | (4.20-6.20) | (4.69-6.85) | |
| lipopolysaccharide | 23.21 | 19.98** | 23.09^{§§} | — |
| endotoxin-binding | (15.54-35.50) | (14.15-30.83) | (11.37-37.06) | |
| protein (μg/ml) | | | | |
| Interleukin 1β (pg/ml) | 0.07 | 0.07 | 0.06 | — |
| | (0.03-0.12) | (0.05-0.15) | (0.03-0.13) | |
| Interleukin 6 (pg/ml) | 2.28 | 2.02* | 1.69**^{§§} | — |
| | (1.79-3.12) | (1.62-2.62) | (1.27-2.47) | |
| Tumor necrosis factor | 1.07 | 1.03 | 1.03* | — |
| α (pg/ml) | (0.87-1.49) | (0.81-1.40) | (0.80-1.54) | |
| adiponectin (μg/ml) | 3.57 | 3.82** | 4.20**^{§} | — |
| | (2.56-5.22) | (2.90-5.90) | (3.00-6.20) | |
| intestinal permeability | 0.026 | 0.022** | 0.023* | — |
| | (0.020-0.031) | (0.019-0.026) | (0.019-0.026) | |

Note:
For the intestinal permeability test, 89 samples were collected 30 days prior to the intervention and 9 weeks after the intervention. 76 samples were collected 23 weeks after the intervention.

A. Compared with the volunteers' physiological and biochemical indicators 30 days prior to the intervention, 9 weeks and 23 weeks after the intervention, the volunteers' body weight and BMI continuously dropped significantly; the decrease in the indicators of fasting glucose, fasting insulin, glycated hemoglobin, and insulin resistance directly reflects the improvement of glucose homeostasis under the intervention; the decline in triglycerides and total cholesterol indicates the improvement of the body's lipid metabolism; the significant reduction of aspartate aminotransferase, alanine aminotransferase and γ-glutamyl transferase indicates the mitigation of the liver cell damage; at the same time, both the fatty liver disease (68.5% of the volunteers' conditions improved under the intervention, among which 18.0% returned to normal) and blood pressure were relieved; the decrease of both the inflammatory indicator C-reactive protein and the inflammatory factors interleukin 6 and tumor necrosis factor −α suggests that the level of the inflammatory response caused by the gut microbiota was reduced under the intervention; the increase of the anti-inflammatory factor adiponectin indicates that the function of the body to eliminate inflammatory response recovered after the intervention; the decrease of the lipopolysaccharide endotoxin binding protein suggests that the level of the endotoxin produced by the bacteria and entering the blood was reduced under the intervention.

B. The intervention by the composition of the present application significantly changed the composition of the intestinal flora. The results of 454 pyrosequencing show that the number of Proteobacteria in the volunteers decreased significantly while the number of Actinomycetes increased significantly after the intervention. Primarily, three families showed obvious changes after the dietary intervention. The numbers of Enterobacteriaceae and Desulfovibrio dropped significantly, while the number of Bifidobacteria increased significantly.

After the intervention, the numbers of two types of common pathogens, Enterobacteriaceae and Desulfovibrio, in the volunteers declined significantly, while the number of Bifidobacteria, which can protect the intestinal barrier, increased significantly. The intestinal permeability was lowered, and the intestinal endotoxins entering the host's circulatory system were reduced, resulting in the decrease of the inflammatory response level in the host and relief of the symptoms of metabolic syndrome.

From the foregoing it will be appreciated that, although specific embodiments of the application have been described herein for purposes of illustration, various modifications may be made without deviating from the spirit and scope of the application. Accordingly, the application is not limited except as by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group. As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. For example, a group having 1-3 cells refers to groups having 1, 2, or 3 cells. Similarly, a group having 1-5 cells refers to groups having 1, 2, 3, 4, or 5 cells, and so forth. While various aspects and embodiments have been disclosed herein, other aspects and embodiments will be apparent to those skilled in the art.

The various aspects and embodiments disclosed herein are for purposes of illustration and are not intended to be limiting, with the true scope and spirit being indicated by the following claims.

1. A composition comprising:
a first composition;
a second composition; and
a third composition,
wherein:
the first composition comprises at least one of whole cereals, beans, nuts, cloves, star anise, fennel, thistle, yam, hawthorn, purslane, Zaocys dhumnades, plum, papaya, hemp seed, odoratum, fragrant Solomonseal rhizome, licorice, angelica, ginkgo, white lentils flower, longan pulp, cassia, lily, nutmeg, cinnamon, amla, bergamot, Hippophae rhamnoides, oysters, Gorgon fruit, pepper, red beans, donkey hide gelatin, inner wall of chicken gizzard, malt, kelp, jujube, Momordica grosvenori, Yu Li seed, honeysuckle flower, olive, Houttuynia cordata, ginger, Hovenia dulcis Thunb, medlar, gardenia, Amomum villosum, Pang Dahai, Poria, citron, Elsholtzia, peach kernel, mulberry leaf, mulberry, orange, bellflower, Alpinia oxyphylla, lotus leaf, semen raphani, lotus seed, Alpinia officinarum hance, Lophatherum gracile, fermented soybean, chrysanthemum, chicory, Huang Jiezi, Huang Jing, perilla seed, perilla seed, Ge Gen, black sesame seed, black pepper, Sophora japonica, sophora flower, dandelion, honey, Torreya, semen Ziziphi Spinosae, fresh Rhizoma imperatae, fresh reed rhizome, viper, orange peel, coix seed, peppermint, Allium macrostemon Bunge, raspberry, or ageratum,
the second composition comprises at least one of bitter gourd, a first fermentable dietary fiber, or a first oligosaccharide, and
the third composition comprises a second fermentable dietary fiber and a second oligosaccharide.

2. The composition of claim 1, wherein the whole cereals comprises at least one of wheat, barley, quinoa, millet, rye, triticale, buckwheat, oat, or corn, wherein the beans comprise at least one of soybeans, black beans, broad beans, white beans, peas, mung bean, long bean, Pigeonpea, four winged bean, chickpea, lentil, red beans, Pinto bean, green bean, kidney bean, Navy bean, Pea bean, Lima bean, black bean, Garbanzo peas, black-eyed peas, lablab bean, white lentils, or red bean, wherein the nuts comprises at least one of peach seeds, almonds, gingko seeds, pr peanuts, and wherein the jujube comprises at least one of Zizyphus jujube, sour jujube, black jujube, or common jujube.

3.-13. (canceled)

14. The composition of claim 1, wherein the first composition comprises, per 100 g, Vitamin A from about 3 to about 857 μgRE, Vitamin D from about 0.01 to about 5 μgRE, Vitamin E from about 2 to about 79.09 mg, Vitamin B₁ from about 0.01 to about 1.89 mg, Vitamin B2 from about 0.01 mg to about 1.4 mg, Vitamin B₆ from about 0.01 to about 1.2 mg, Vitamin B₁₂ from about 0.1 to about 2.4 mg, Vitamin C from about 1 mg to about 1170 mg, Niacin from about 0.5 mgNE to about 28.4 mg, Ca from about 60-2458 mg, P from about 200 to about 1893 mg, K from about 350 to about 1796 mg, Na from about 8 to about 2200 mg, Mg from about 100 to about 350 mg, and Fe from about 2 to about 20 mg.

15.-17. (canceled)

18. The composition of claim 17, wherein the whole cereals comprises whole cereals particles, and wherein at least about 25% of the whole cereal particles have a diameter of at least 0.65 mm.

19. The composition of claim 1, wherein the first composition is capable of increasing short-chain fatty acid (SCFA)-producing bacteria population in a subject.

20. The composition of claim 1, wherein the second composition consists essentially of the bitter gourd, the first fermentable dietary fiber, and the first oligosaccharides.

21.-23. (canceled)

24. The composition of claim 1, wherein the first or the second fermentable dietary fiber comprises at least one of Fibersol-2, resistant starch, polydextrose, cellulose, hemicellulose, pectin, or gum, respectively.

25. The composition of claim 1, wherein the first or the second oligosaccharides comprises at least one of fructooligosaccharides, galacto-oligosaccharides, lactulose, xylo isomaltooligosaccharide, soybean oligosaccharides, oligo glucose, Stachyose, or Lactosucrose, respectively.

26. The composition of claim 1, wherein the second composition comprises the bitter gourd in about 15% to about 99.8% by weight, the first fermentable dietary fiber in an amount from about 0.1% to about 51% by weight, and the first oligosaccharide in an amount from about 0.1% to about 34% by weight.

27. (canceled)

28. The composition of claim 1, wherein the second composition is capable of reducing endocrine toxin-producing bacteria population in a subject.

29. A nutritional intervention composition comprising:
a first composition;
a second composition; and
a third composition,
wherein:
the first composition comprises an ingredient from an edible plant,
the second composition comprises at least one of bitter gourd, a first fermentable dietary fiber, or a first oligosaccharide, and
the third composition comprises a second fermentable dietary fiber or a second oligosaccharide, or a combination thereof.

30. The nutritional intervention composition of claim 29, wherein the first composition comprises adlay, oat, and buckwheat.

31. The nutritional intervention composition of claim 29, wherein the first composition comprises white Hyacinth bean, yellow corn, red bean, soybean, yam, peanut, lotus seed and wolfberry.

32. The nutritional intervention composition of claim 29, wherein the first composition comprises protein from about 10% to about 20% by weight, fat from about 2% to about 15% by weight, carbohydrate from about 50% to about 70% by weight, and fermentable dietary fibers from about 2% to about 155 by weight.

33. The nutritional intervention composition of claim 29, wherein, when ingested by a subject in effective amount, the nutritional intervention composition is capable of increasing a first gut microbiota population or decreasing a second gut microbiota population in the subject, wherein the first gut microbiota population comprises a short-chain fatty acid (SCFA)-producing bacteria, and wherein the second gut microbiota population comprises an endotoxin producing bacteria.

34. The nutritional intervention composition of claim 29, wherein, when ingested by a subject in effective amount, the first composition is capable of increasing a first gut microbiota population, and the second composition is capable of decreasing a second gut microbiota population in the subject, wherein the first gut microbiota population comprises a short-chain fatty acid (SCFA)-producing bacteria, and wherein the second gut microbiota population comprises an endotoxin producing bacteria.

35. (canceled)

36. A method for nutritional intervention in a subject, comprising
providing the subject a nutritional intervention composition comprising a first composition, a second composition and a third composition,
wherein:
the first composition comprises an ingredient from an edible plant,
the second composition comprises at least one of bitter gourd, a first fermentable dietary fiber, or a first oligosaccharide, and
the third composition comprises a second fermentable dietary fiber or a second oligosaccharide, or a combination thereof; and
providing the subject with the first composition as a main course of food, with the second composition from about 0.25 to about 1 hour before a meal, and with the third composition from about 2 to about 5 hours before the meal or alone with a breakfast.

37. The method of claim 36, wherein the first composition comprises an ingredient from an edible plant, wherein the first composition is capable of increasing a first gut microbiota population or decreasing a second gut microbiota population in the subject after a period of time, wherein the first gut microbiota population comprises a short-chain fatty acid (SCFA)-producing bacteria, and wherein the second gut microbiota population comprises an endotoxin producing bacteria.

38. The method of claim 36, wherein the second composition is capable of increasing a first gut microbiota population or decreasing a second gut microbiota population in the subject after a period of time, wherein the first gut microbiota population comprises a short-chain fatty acid (SCFA)-producing bacteria, and wherein the second gut microbiota population comprises an endotoxin producing bacteria.

39. The method of claim 36, wherein the third composition is capable of accelerating intestinal motility or emptying rate, wherein the third composition is capable of increasing a first gut microbiota population or decreasing a second gut microbiota population in the subject after a period of time, wherein the first gut microbiota population comprises a short-chain fatty acid (SCFA)-producing bacteria, and wherein the second gut microbiota population comprises an endotoxin producing bacteria.
